(19) United States
(12) Patent Application Publication
(10) Pub. No.: US 2026/0279375 A1
(43) Pub. Date: Sep. 17, 2026

(54) DYNAMIC MICROPHONE SIGNAL PROCESSING BASED ON CURRENT LANGUAGE CONTEXT

(71) Applicant: Sony Interactive Entertainment Inc., Tokyo (JP)

(72) Inventors: Sarah Anne Karp, San Mateo, CA (US); Kristie Renee Ramirez, San Jose, CA (US)

(73) Assignee: Sony Interactive Entertainment Inc., Tokyo (JP)

(21) Appl. No.: 19/079,338

(22) Filed: Mar. 13, 2025

(51) Int. Cl. G10L 21/0216; G10L 15/00

(52) U.S. Cl. CPC G10L 21/0216; G10L 15/005; G10L 2021/02163

(57) ABSTRACT

Microphone signal processing (e.g., noise cancellation) can be dynamically modified based on a current language context. For example, given a baseline noise cancellation filter, a set of language-specific filters can be defined to be used together with the baseline noise cancellation filter. When audio data is received from a microphone, a current language context, indicative of a language currently being spoken into the microphone, can be determined automatically or based on a user-selectable setting. A particular language-specific filter can be selected from the filter set based at least in part on the current language context, and the baseline noise cancellation filter and the selected language-specific filter can be applied to the audio data.

### BACKGROUND

This disclosure relates generally to audio signal processing and in particular to dynamic microphone signal processing based on a current language context.

In simplest terms, a microphone is an electronic device that converts sound waves to electrical signals that can be stored and/or transmitted to a receiving device (e.g., a speaker system) that can convert the electrical signals back to sound waves.

Microphones are often used to capture speech (the sound of a person speaking words into the microphone); however, they can also be sensitive to environmental noise, including constant noises such as fans or motors, as well as sporadic noise such as keyboards clicking, papers rustling, or background music or other conversation. (As used herein, “noise” refers generally to any unwanted sound that may be captured by a microphone.) Accordingly, many microphone systems include audio processing components, such as digital signal processors, that implement various signal processing operations designed to remove or suppress the noise and/or to enhance the speech sounds. Examples include selectively suppressing or boosting certain frequencies in the audio signal, introducing an interfering signal in the time domain that cancels a noise component of the signal, or the like. Suppressing or cancelling noise without also suppressing useful speech sounds poses numerous challenges.

### SUMMARY

Some of the challenges in microphone noise cancellation relate to differences between languages. For instance, some noise cancellation techniques include training a machine-learning model using training samples that are generated by mixing a clean speech signal (recorded under low-noise conditions) with various types and combinations of background noise. The machine-learning model can learn to extract the clean speech signal from the mixed signal and noise. Such training generally requires selection of a particular language (or languages) for which the model is to be trained. However, since languages differ in their acoustic characteristics, a model trained on one language (or set of languages) may not be optimal for noise cancellation when the user is speaking a language that the model was not trained on.

Certain embodiments described herein relate to noise cancellation techniques for microphone systems that can dynamically adapt to different languages without the need for training a machine-learning model for each language. For example, a microphone system may employ a “baseline” noise cancellation model, which can be a machine-learning model that has been trained using a particular “baseline” language. Based on analysis of differences in acoustic characteristics between the baseline language and an alternative language (or “target” language), a language-specific filter can be applied before or after the baseline noise cancellation model, e.g., to boost certain frequencies and/or reduce certain other frequencies.

According to some embodiments, a method for processing audio data can include: receiving audio data from a microphone; determining a current language context for the audio data, the current language context indicative of a language currently being spoken into the microphone; selecting a first language-specific filter from a filter set based at least in part on the current language context, wherein the filter set includes a plurality of language-specific filters corresponding to different language contexts, the plurality of language-specific filters including the first language-specific filter; and applying a plurality of filters, including a baseline noise cancellation filter and the first language-specific filter, to the audio data to produce filtered audio data. In various embodiments, the audio data can be received as digital audio data or as an analog audio signal that is converted to digital audio data. In various embodiments, the filtered audio data can be transmitted to an audio receiver system via a network.

According to some embodiments, a system can include: a microphone; a memory; and a processor coupled to the memory and the microphone. The processor can be configured to: receive audio data from the microphone; determine a current language context for the audio data, the current language context indicative of a language currently being spoken into the microphone; select a first language-specific filter from a filter set based at least in part on the current language context, wherein the filter set includes a plurality of language-specific filters corresponding to different language contexts, the plurality of language-specific filters including the first language-specific filter; and apply a plurality of filters, including a baseline noise cancellation filter and the first language-specific filter, to the audio data to produce filtered audio data. In various embodiments, the audio data can be received as digital audio data or as an analog audio signal that is converted to digital audio data. In various embodiments, the system can further include a network interface, and the processor can be further configured to transmit the filtered audio data to an audio receiver system using the network interface.

According to some embodiments, a computer-readable storage medium can have stored therein program code instructions that, when executed by a processor in a computer system, cause the processor to perform a method comprising: receiving audio data from a microphone; determining a current language context for the audio data, the current language context indicative of a language currently being spoken into the microphone; selecting a first language-specific filter from a filter set based at least in part on the current language context, wherein the filter set includes a plurality of language-specific filters corresponding to different language contexts, the plurality of language-specific filters including the first language-specific filter; and applying a plurality of filters, including a baseline noise cancellation filter and the first language-specific filter, to the audio data to produce filtered audio data. In various embodiments, the audio data can be received as digital audio data or as an analog audio signal that is converted to digital audio data. In various embodiments, the filtered audio data can be transmitted to an audio receiver system via a network.

In these and other embodiments, determining the current language context can include analyzing audio data received from the microphone. Additionally or instead, the method can also include receiving and storing a language selection input from a user, and determining the current language context can be based at least in part on the language selection input.

In these and other embodiments, the language-specific filters can based at least in part on differences between phoneme sets of different spoken languages and/or differences in vocalization characteristics between different spoken languages.

In these and other embodiments, the baseline noise cancellation filter can comprise a trained machine-learning model that was trained using a baseline language that is different from the language currently being spoken into the microphone.

In these and other embodiments, the method can also include: obtaining a plurality of speech samples including speech samples in each of a plurality of different languages; analyzing the speech samples to determine language-specific audio characteristics; for each of the different languages, defining a language-specific filter based at least in part on the language-specific audio characteristics; and storing the language-specific filters in the filter set.

The following detailed description, together with the accompanying drawings, will provide a better understanding of the nature and advantages of the claimed invention.

### BRIEF DESCRIPTION OF THE DRAWINGS

FIG. 1 shows a simplified block diagram of an audio system according to some embodiments.

FIG. 2 shows a simplified block diagram of a digital signal processor (DSP) according to some embodiments.

FIG. 3 shows a flow diagram of a process for developing a language-specific filter for a target language according to some embodiments.

FIG. 4 shows a flow diagram of a process for audio data filtering that can be implemented in a microphone system according to some embodiments.

FIGS. 5A and 5B illustrate examples of operating environments in which various embodiments can be incorporated.

FIG. 6 shows a simplified block diagram of a hardware system suitable for implementing a computer system according to some embodiments.

### DETAILED DESCRIPTION

The following description of exemplary embodiments is presented for the purpose of illustration and description. It is not intended to be exhaustive or to limit the claimed embodiments to the precise form described, and persons skilled in the art will appreciate that many modifications and variations are possible. The embodiments have been chosen and described in order to best explain their principles and practical applications to thereby enable others skilled in the art to best make and use various embodiments and with various modifications as are suited to the particular use contemplated.

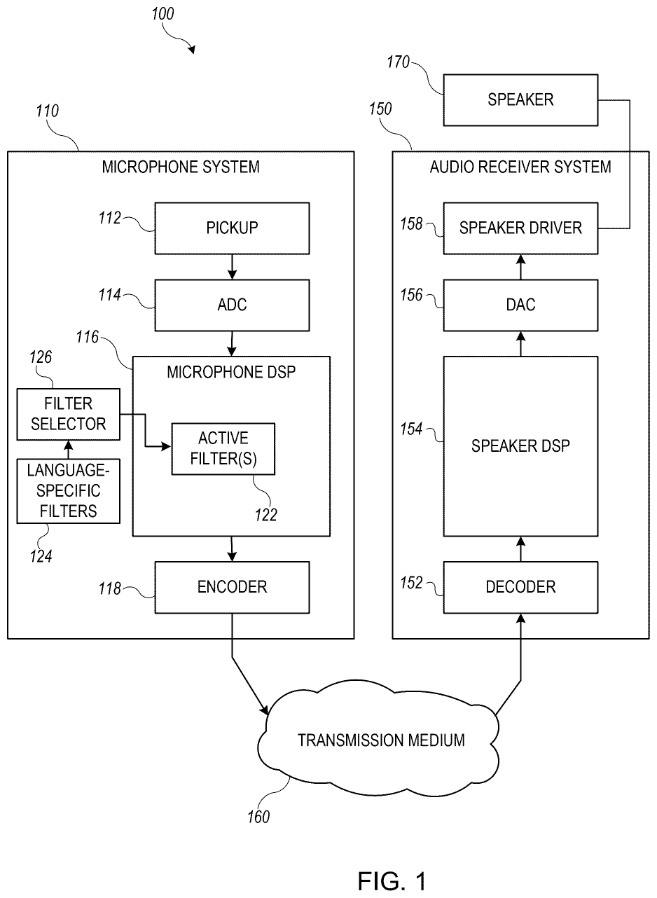

FIG. 1 shows a simplified block diagram of an audio system 100 according to some embodiments. Audio system 100 includes a microphone system 110 and an audio receiver system 150. Audio signals (in digital form) can be passed from microphone system 110 to audio receiver system 150 via a transmission medium 160.

Microphone system 110 can include a pickup device 112, an analog-to-digital converter circuit (ADC) 114, a digital signal processing unit (DSP) 116, and an encoder 118. Pickup device 112 can include a transducer that converts sound waves (acoustic vibrations) to an analog electrical signal. The particular implementation of pickup device 112 can be varied as desired. In some embodiments, multiple pickup devices 112 at different locations can be provided (e.g., for producing multi-channel audio and/or for environmental noise detection). ADC 114 can include circuitry that samples the analog electrical signal from pickup device 112 and generates a digital representation of the signal, also referred to as digital audio data. The particular implementation of ADC 114 can be varied as desired.

Microphone DSP 116 can be implemented using one or more microprocessors, microcontrollers, or other programmable and/or fixed-function digital logic circuits. Microphone DSP 116 can receive the digital audio data from ADC 114 and can apply one or more active filters 122 to the digital audio data. Active filters 122 can perform noise reduction and/or noise cancellation using one or more processes, and the term “filtering” as used herein refers generally to any process that modifies digital audio data. In various implementations, noise reduction and/or noise cancellation processes can include subtractive filtering (e.g., filtering out low and high frequencies not associated with speech sounds), additive filtering (e.g., boosting certain frequencies associated with speech sounds), active noise cancellation (e.g., applying an interfering signal to cancel out noise), machine-learning-based noise cancellation (e.g., applying a trained machine-learning model to extract just the voice component of the digital audio data), or other processes. According to some embodiments, microphone DSP 116 can include or have access to a set of stored language-specific filters 124 that have been optimized for different languages that a user of microphone system 110 might be speaking. A filter selector 126 can determine a current language context (as described below) and select an appropriate one of language-specific filters 124 to be applied as one of active filters 122. Specific examples of microphone DSP 116 and language-specific filters 124 are described below.

After filtering by microphone DSP 116, the filtered digital audio data can be provided to encoder 118. Encoder 118, which can be implemented using circuitry and/or software executing on programmable processing circuits, can encode the data for transmission via transmission medium 160. The particular operation of encoder 118 can be varied according to the particular transmission medium 160, including associated protocols. For instance, transmission medium 160 can be a wireless medium implemented using a wireless communication protocol such as Bluetooth or Wi-Fi or a proprietary protocol defined for a particular audio system 100. Transmission medium 160 can also be implemented using a wired medium with protocols such as USB audio protocols. It should be understood that transmission medium 160 can involve multiple transmission media and associated protocols. For instance, a point-to-point protocol such as Bluetooth or USB may be used to transfer data from a microphone to a base device (e.g., a phone, laptop computer, gaming console, or the like), and the base device may use IP protocols or the like to transmit the data to a remote receiver (e.g., via the internet). The particular channel or channels to be supported can be selected and implemented as desired.

Audio receiver system 150 can drive a speaker 170 to produce audible sound based on received audio data. Audio receiver system 150 can include a decoder 152, a speaker DSP 154, a digital-to-analog converter circuit (DAC) 156, and a speaker driver 158 that can drive an audio speaker 170. Decoder 152 can decode the encoded audio data received via transmission medium 160. Decoded audio data can be processed by speaker DSP 154, which can perform various signal processing operations, such as an equalizer filter tuned to the audio response characteristics of a particular speaker 170, noise cancellation filters to compensate for noise in the environment around speaker 170, and so on. DAC 156 can convert the audio data output from speaker DSP 154 to an analog signal that can be delivered to speaker driver 158, which can drive an electrical-to-acoustic transducer in speaker 170. The particular implementation of audio receiver system 150 can be independent of any processing performed by microphone DSP 116, and further description of audio receiver system 150 is omitted.

It will be appreciated that audio system 100 is illustrative and that variations and modifications are possible. For instance, components of microphone system 110 can be implemented in a single device or multiple devices as desired. In some embodiments, front-end components such as pickup device 112 and ADC 114 can be incorporated in a wearable device (e.g., a headset or earbuds or lapel mic) while microphone DSP 116 and encoder 118 are incorporated in a “base” device (e.g., a laptop or desktop computer, gaming console, or phone) that communicates with the wearable device via wired or wireless connections and protocols. Other configurations are also possible. For instance, some signal processing operations may be implemented in the wearable device while other operations are implemented in the base device, or the wearable device can provide analog audio to a base device that includes ADC 114 as well as microphone DSP 116 and encoder 118. In various embodiments, pickup device 112 (and optionally other components) can be placed in a handheld or standalone microphone or in another peripheral device such as a camera with integrated microphone, or pickup device 112 can be incorporated into a base device.

It should also be understood that some audio systems can receive and process multiple audio signals, or audio channels, in parallel (e.g., signals from multiple microphones). Some aspects of processing of multi-channel audio signals can be performed independently for each audio channel, while other aspects may incorporate data from two or more audio channels. For instance, noise cancellation may use one or more audio channels (e.g., from microphone pickup devices oriented away from the user's mouth) as representative of environmental noise. As another example, for multichannel audio (e.g., stereo, quadrophonic, or spatial audio), the user's voice may be captured by two or more spatially separated microphone pickup devices. Signal processing can use data from both pickup devices together.

In addition, microphone system 110 or similar systems can be used in a variety of contexts. In the example shown in FIG. 1, microphone system 110 transmits audio data to an audio receiver system 150 that can play back the audio data through speaker 170. However, microphone system 110 can also be used for other purposes. For example, microphone system 110 can be part of an audio recording system that stores audio data output from microphone system 110 (using local and/or remote storage devices as desired); a speech-to-text system that converts the speech component of audio data to text (e.g., for automated transcription); or other systems as desired. Embodiments described herein can be used in any context where a microphone is operated to capture user speech.

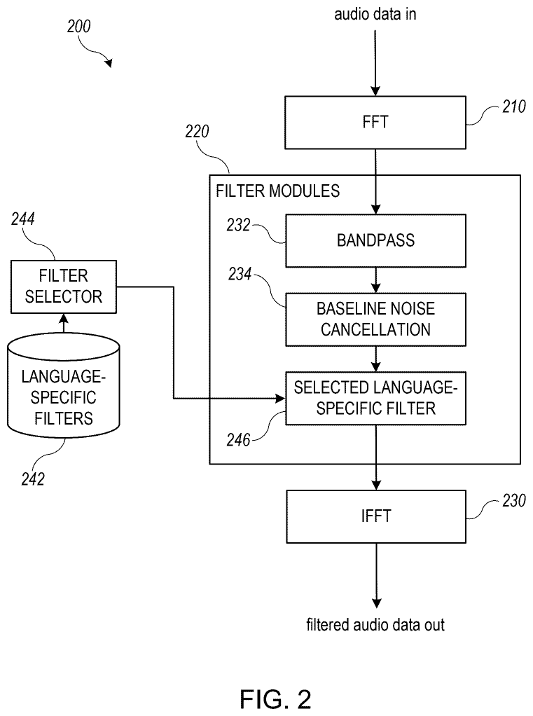

FIG. 2 shows a simplified block diagram of a DSP 200 according to some embodiments. DSP 200 can be used to implement microphone DSP 116 of FIG. 1 or other microphone signal processing. In various embodiments, DSP 200 can be implemented using a programmable processor that executes program code to perform various operations, including operations described herein, or a fixed-function processor, or any combination of fixed-function and programmable processors.

DSP 200 can include a Fast Fourier Transform (FFT) module 210, one or more filter modules 220, and an inverse FFT (IFFT) module 230. FFT module 210 can receive digital audio data (e.g., from ADC 114 of FIG. 1) and convert the digital data from time domain to frequency domain. Filter modules 220 in DSP 200 can operate on frequency-domain and/or time-domain data (or a combination thereof) as desired. IFFT module 230 can convert frequency-domain data back to time domain to facilitate downstream processing (e.g., transmission to a receiver). In some embodiments, the next downstream processing stage may operate on frequency-domain data, and IFFT module 230 can be omitted or bypassed as appropriate.

Filter modules 220 can include a bandpass filter 232 to eliminate high and low frequencies that are outside the likely frequency range of the human voice. For instance, bandpass filter 232 can pass frequency components in a range from about 50 Hz to about 14 kHz or from about 20 Hz to about 20 kHz. The particular range can be chosen as desired, e.g., depending on the fidelity requirements or expectations of a particular microphone system. In some embodiments, bandpass filter 232 can also incorporate an equalizer to adjust the relative gain of different frequencies (e.g., to account for nonuniformity in the response of microphone pickup device 112). In some embodiments, bandpass filter 232 is can be omitted in favor of other signal processing.

Filter modules 220 can also include a baseline noise cancellation module 234. Baseline noise cancellation module 234 can be designed to separate speech elements from background noise. In some embodiments, baseline noise cancellation module 234 can include a trained machine-learning model that receives a “mixed” input signal containing both speech and noise and outputs a “clean” signal representing the speech component. Other noise cancellation techniques can also be incorporated, including active noise cancellation based on secondary microphones that are placed to detect environmental noises. The particular implementation of baseline noise cancellation module 234 can be varied as desired. For purposes of the present disclosure, it is assumed that baseline noise cancellation module 234 has been optimized for a particular language, referred to herein as a “baseline” language (or “L1”). For example, a machine-learning model can be trained using a training data set that is dominated by samples of speech in the baseline language.

According to some embodiments, filter modules 220 can also include language-specific filtering. In particular, where baseline noise cancellation module 234 is trained on a baseline language L1 and the user is speaking a different language (referred to herein as a “target” language, or language “L2”), baseline noise cancellation module 234 may distort the user's speech. For example, baseline noise cancellation module 234 may reduce or remove certain acoustic features that are important to comprehension of language L2, or baseline noise cancellation module 234 may leave in certain acoustic features that do not correspond to sounds in language L2. As described below, a set of language-specific filters 242 can be created based on analysis of different target languages relative to the baseline language. Each language-specific filter 242 can be, for example, an equalizer-type filter that applies different weights to different frequency components to selectively increase or decrease the relative energy of different frequency components. The weights can be defined based on differences in acoustic characteristics between the baseline language L1 and language L2. Other implementations are also possible; examples are described below.

To apply a language-specific filter, DSP 200 can include a filter selector module 244 that determines a current language context (e.g., which language the user is most likely speaking) and selects one of language-specific filters 242 to be activated based on the current language context. The selected language-specific filter 246 can be applied to the audio data. In the embodiment shown in FIG. 2, selected language-specific filter 246 is applied to the output of baseline noise cancellation module 234; however, alternative implementations are possible. For example, it may be desirable to apply selected language-specific filter 246 ahead of baseline noise cancellation module 234. It should be understood that, in some instances, filter selector module 244 might not select any language-specific filter 242. For instance, if the user is speaking the baseline language, additional language-specific filtering can be omitted.

In some embodiments, baseline noise cancellation module 234 need not be optimized for any particular language. For instance, the training data for baseline noise cancellation module 234 can include samples of speech in several different languages. In this case, the “baseline language” can be understood to be an amalgam of the training languages and need not correspond to any natural language. Language-specific filters can be developed for particular natural languages relative to the amalgam baseline language.

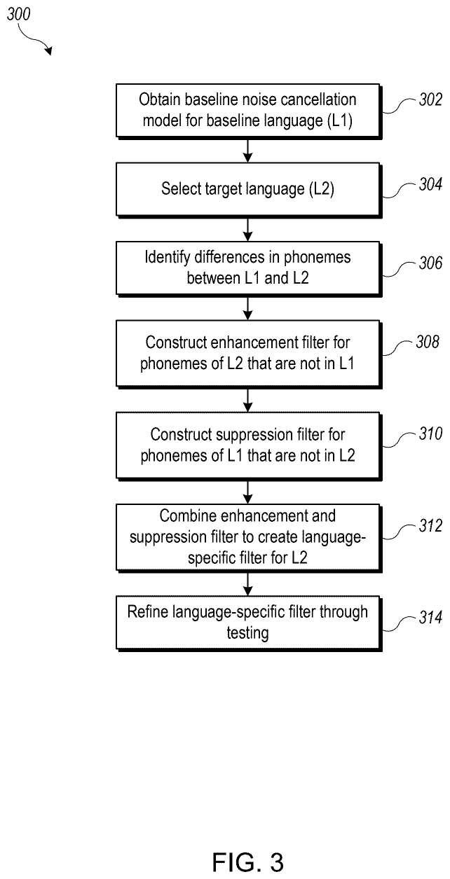

FIG. 3 shows a flow diagram of a process 300 for developing a language-specific filter for a target language L2 according to some embodiments. In this example, the language-specific filter is designed to be used in combination with a baseline noise cancellation model trained on a baseline language L1.

Process 300 leverages an observation from the field of linguistics that any spoken human language can be decomposed into elementary sound elements, referred to as “phonemes.” Examples include vowel sounds (e.g., long “o”, short “a”, schwa, etc.) and consonant sounds (sibilant “s”, hard “g”, soft “g”, glottal stop, etc.). These phonemes are combined into syllables and/or words to convey meaning in a given language. In order to understand speech in a given language, a listener needs to be able to recognize and distinguish the phonemes of that language. Conversely, the listener may regard sounds that do not correspond to phonemes of a given language as noise, even if the sounds are phonemes in another language. Linguists estimate that more than 800 phonemes exist in human languages worldwide, although any given language uses only a subset (typically a few dozen) of these phonemes. For example, according to estimates by various linguists, English has 44 phonemes; Mandarin has 29; Japanese has around 22; other languages range from around 10 to around 110 phonemes.

Accordingly, in the context of noise-cancellation processing for user speech, it is desirable to preserve phonemes of the particular language being spoken while filtering out other sounds. To the extent that different languages have different sets of phonemes, optimal noise cancellation processing will be different for different languages. Process 300 leverages comparative analysis of phonemes in different languages to modify a noise-cancellation process that was optimized for a baseline language and thereby provide better performance in a target language that uses different phonemes.

Process 300 can begin at block 302, where a baseline noise cancellation model for baseline language L1 is obtained. For example, as described above, a machine-learning model can be trained using audio samples that are constructed by mixing “clean” recorded samples of speech in baseline language L1 with various types of noise. The input to the model can be a representation of audio data received from a microphone (e.g., a frequency-domain representation of a time interval such as second or half-second or the like and/or a sequence of time-domain audio samples over some time interval), and the output of the model can be a corresponding representation of the clean audio data in which the speaker's voice is enhanced and/or background noise is removed; training can involve minimizing a loss function based on the difference between the outputs of the model and the original clean samples of speech. During training, the model implicitly or explicitly learns to recognize audio characteristics of phonemes and/or sequences of phonemes (e.g., syllables) that occur in baseline language L1. Depending on implementation, block 302 can include selecting the baseline language and training the baseline noise cancellation model or obtaining a pre-trained baseline noise cancellation model that has been trained using a baseline language. (As described above, the baseline language can be an amalgam of multiple natural languages.)

At block 304 a target language L2 can be selected. The target language L2 can be any language other than baseline language L1, and no particular relationship between L1 and L2 is required. For example, if L1 is English, L2 could be French, Spanish, Japanese, Mandarin, Swahili, Hindi, or any other language. In some embodiments, L1 and L2 can be different (mutually intelligible) dialects of a language; for instance, L1 can be U.S. English while L2 is British English or Australian English.

At block 306, differences in phonemes between L1 and L2 can be identified. For example, a list of phonemes used in L1 and a list of phonemes used in L2 can be compared to identify phonemes that are used in L1 but not in L2, phonemes that are used in L2 but not in L1, and phonemes that are common to both languages. In some embodiments, phoneme frequency can be considered, and phonemes that occur with less than a threshold frequency in a particular language can be treated as not occurring in that language.

For phonemes that occur in L2 but not in L1, the baseline noise cancellation model may suppress the sounds, thereby making it harder to understand speech in L2, and for phonemes that occur in L1 but not in L2, the baseline noise cancellation model may retain or even enhance the sounds even though in the context of L2, those sounds are noise that do not facilitate (and may interfere with) comprehension.

Accordingly, additional filters can be constructed to offset undesired effects of the baseline noise cancellation model on speech in L2. For example, at block 308, an “enhancement” filter can be constructed to enhance phonemes of L2 that are not in L1, and at block 310, a “suppression” filter can be constructed to reduce phonemes of L1 that are not in L2. In some embodiments, the enhancement and suppression filters can be equalizer-type filters that change the relative gain of different frequency components of the audio signal. At block 312, the enhancement and suppression filters can be combined to create a language-specific filter for L2. In some embodiments, the language-specific filter for L2 can be designed to operate on the output of the baseline noise cancellation model. Alternatively, the language-specific filter for L2 can be designed to operate on the audio data prior to inputting the audio data to the baseline noise cancellation model. In some embodiments, the language-specific filter for L2 can include a first (“pre-filter”) component that operates prior to the baseline noise cancellation model and a second (“post-filter”) component that operates on the output of the baseline noise cancellation model. For instance, it may be desirable to apply the enhancement filter from block 308 ahead of the baseline noise cancellation model (which can prevent the baseline model from overly suppressing phonemes of L2 that are absent from L1) and to apply the suppression filter from block 310 to outputs of the baseline noise cancellation model (which can reduce or remove phonemes of L1 that were preserved or enhanced by the baseline model but are not in L2).

At block 314, the language-specific filter can be refined through testing. For example, DSP 200 of FIG. 2 can be used to perform filtering on speech samples, and A/B testing procedures can be used to compare different settings for the language-specific filter. In some embodiments, A/B testing can include asking listeners to evaluate intelligibility and/or fidelity of the processed audio relative to the original speech. A/B testing can also be partially or entirely automated. For instance, automated processes can be used to compare different audio waveforms produced by DSP 200 with different settings applied to the language-specific filter to the waveform of clean input speech. As another example, audio waveforms produced by DSP 200 can be input to a speech-to-text system that has been trained for language L2, enabling assessment of how changes in the settings for the language-specific filter affect accuracy of the resulting text.

Process 300 is illustrative, and other implementations are also possible. For example, the language-specific filter for L2 can be implemented using a second machine-learning model that is designed as a lightweight “downstream” layer applied to outputs of the baseline noise cancellation model. Training of an L2-specific noise cancellation layer can include inputting recorded samples of clean speech in L2 to the trained baseline noise cancellation model, from which the L2-specific noise cancellation layer can learn to recover the input clean speech in L2 from the output of the baseline noise-cancellation model while the parameters of the baseline noise cancellation model are held constant. As another example the second machine-learning model can be designed as a lightweight “upstream” layer that is applied to the audio data prior to the baseline noise cancellation model, with a similar training procedure. In some embodiments, a language-specific filter can include both an upstream layer and a downstream layer, with joint training of both layers. In some embodiments, the training samples for the L2-specific noise cancellation layer can be selected to highlight phonemic differences between L2 and L1 or to represent the relative frequencies of phonemes in L2.

In addition or instead, a language-specific filter can be used in connection with other baseline noise cancellation models or processes, not limited to machine-learning models. By way of illustration, a baseline noise cancellation process may include a filter that selectively reduces certain frequencies. One example is a de-esser, which is a well-known type of filter that selectively reduces sibilance. A de-esser optimized for one language may adversely affect phonemes of a language that has more (or less) sibilance, and in some embodiments, a language-specific filter can reduce or cancel the effect of a de-esser.

In various embodiments, a language-specific filter can be defined for a given target language L2 using principles and techniques described herein. It should be understood that any number of language-specific filters can be defined, each specific to a different target language L2. In some embodiments, target languages can be grouped, e.g., based on similarity of phonemes used, and a single language-specific filter can be defined for a group of target languages. Sample speech for training a language-specific filter for a group of target languages can include utterances in different languages in the group.

The phoneme-based approach can also be modified. For instance, languages can be analyzed at the level of syllables or patterns of phonemes, and filters can be developed to enhance or suppress syllables rather than individual phonemes. In addition or instead, some languages may have acoustic characteristics that are not tied to particular phonemes. For instance, French sounds tend to be nasal; Mandarin uses tonality in addition to phonemes to convey meaning; and so on. In some embodiments, language-specific filters can include filters designed to preserve such acoustic characteristics (e.g., by providing less suppression or even selective enhancement of various harmonics or frequency ranges).

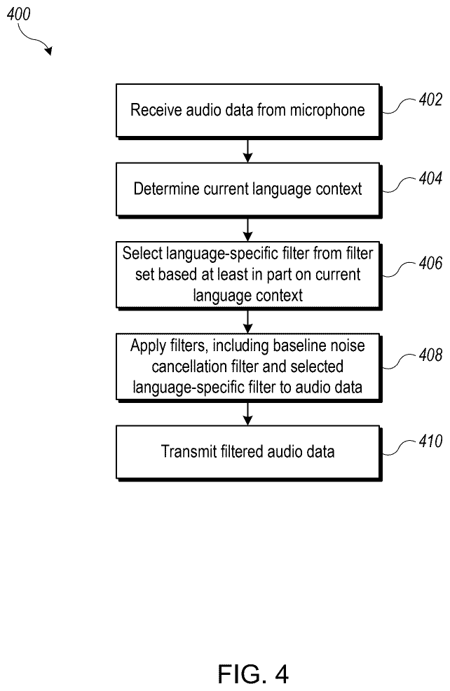

Once a set of language-specific filters has been defined for a particular baseline noise cancellation model or process, a language-specific filter from the set of language-specific filters can be selectably applied, depending on which language is being spoken. In some embodiments, selection of a language-specific filter can be a dynamic process. FIG. 4 shows a flow diagram of a process 400 that can be implemented in a microphone system (e.g., microphone system 110 of FIG. 1) according to some embodiments.

At block 402, audio data is received from a microphone. For example, in microphone system 110, pickup device 112 and ADC 114 can be operated to detect sound and produce corresponding digital audio data. It is assumed that the digital audio data includes a combination of user speech and noise. In some embodiments, a prefiltering stage (e.g., in microphone DSP 116) can be applied to determine whether user speech is actually present (e.g., based on amplitude and/or frequency characteristics of the digital audio data); conventional or other techniques can be used. Where a prefiltering stage detects no speech, the audio data can be suppressed or replaced with data representing absence of sound, e.g., to avoid transmitting pure noise to the receiver system.

At block 404, assuming the audio signal is not being suppressed, process 400 can determine a current language context for user speech. The current language context reflects a determination made by microphone system 110 as to what language the user is currently speaking. In various embodiments, one or more different techniques can be used to determine a current language context. For example, microphone system 110 may be coupled to a computer system (e.g., a game console, handheld device, laptop computer, desktop computer, or the like) that provides a user interface via which the user can select a language, and the user's language selection may be treated as the current language context. As another example, if microphone system 110 can determine its current geographic location (e.g., via Global Positioning System (GPS) or other global navigation satellite system, cellular triangulation, Wi-Fi fingerprinting, or the like), the geographic location can be used to infer a language context. As yet another example, if microphone system 110 can deliver audio data to a computer system that has speech recognition or speech analysis capability, the computer system can analyze the audio data from microphone system 110, determine the language being spoken, and provide language identification information as feedback to microphone system 110. As still another example, recent utterances of the user can be analyzed for phonemic content, which can be matched to a phonemic profile for a language or group of languages, thereby identifying a current language context.

At block 406, process 400 can select a language-specific filter from a stored filter set, based at least in part on the current language context. For example, filter selector 126 (FIG. 1) can use the current language context to identify and select a particular filter from the set of language-specific filters 124. In one example implementation, filter selector 126 can access a lookup table that maps identifiers of language contexts to identifiers of corresponding language-specific filters (e.g., pointers to locations where code or parameters implementing particular filters are stored). In some embodiments, there need not be a language-specific filter selected for every possible language context. For instance, if the current language context corresponds to the baseline language L1 (for which the baseline noise cancellation is optimized), filter selector 126 might not select any language-specific filter. As another example, the set of language-specific filters might not cover every language known to humanity, or the user might be speaking an invented language for which a language context cannot be determined. In instances where the current language context cannot be determined or does not correspond to any of the stored language-specific filters, process 400 might not select any language-specific filter.

At block 408, process 400 can apply filters to the audio data. The filters can include the baseline noise cancellation filter (which can include a trained machine-learning model and/or other filters as described above) and the language-specific filter that was selected at block 406. As described above, a selected language-specific filter can be applied before and/or after the baseline noise cancellation filter.

At block 410, process 400 can transmit the filtered audio data to a receiver, e.g., via encoder 118 and transmission medium 160. Transmitting can include local or remote transmission, and the receiver can be any device or system that is capable of storing, playing back, and/or analyzing audio data that represents user speech. In some embodiments, the filtered audio data can be transmitted to a downstream process executing in the same computer system or device that implements process 400.

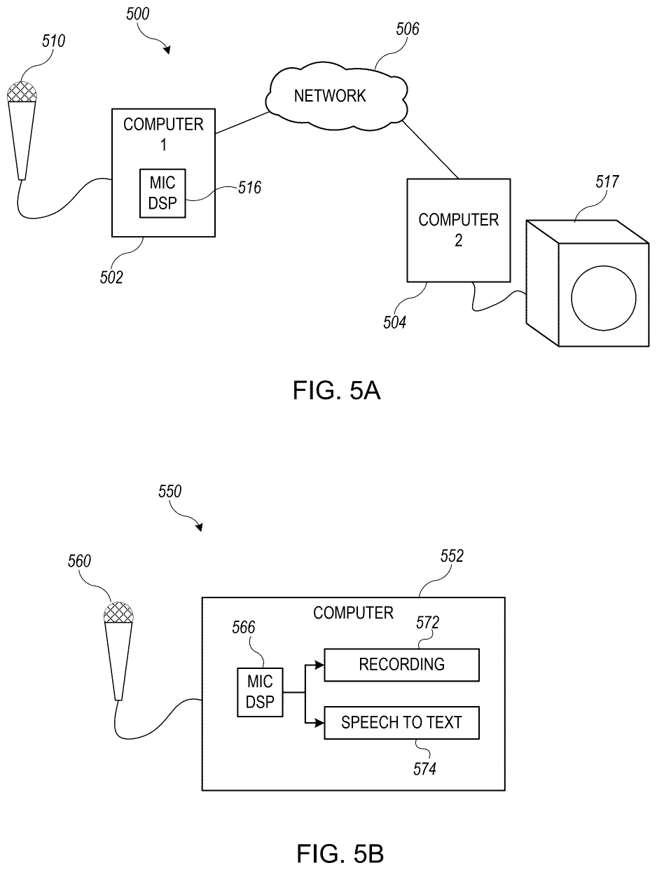

FIGS. 5A and 5B illustrate examples of operating environments in which various embodiments can be incorporated. FIG. 5A illustrates a network environment 500 according to some embodiments. In network environment 500, a first computer system 502 and a second computer system 504 communicate via a network 506, which can be a wide-area network such as the internet or a local network or other network as desired. First computer system 502 is coupled to a microphone 510. Microphone 510 can be a peripheral device, such as a handheld device, a wearable device (e.g., headset or earbud microphone, lapel mic, or the like), a stand-mounted device (e.g., in a webcam or freestanding microphone, or mounted in or on a housing of computer system 502), and microphone 510 can communicate with computer system 502 via a local connection such as USB, Bluetooth, an analog signal path, or the like; the connection can be wired or wireless. Microphone 510 and first computer system 502 can implement microphone system 110 of FIG. 1. For example, first computer system 502 can include a microphone DSP 516 (corresponding to microphone DSP 116 of FIG. 1 or DSP 200 of FIG. 2). Process 400 or similar processes can be implemented in microphone DSP 516 to apply baseline noise cancellation and a language-specific filter to audio data from microphone 510, and first computer system 502 can transmit the filtered audio data via network 506 to second computer system 504. Second computer system 504 can include audio processing circuitry and software to produce signals to drive an audio speaker 517, e.g., implementing audio receiver system 150 of FIG. 1. In this manner, a user of computer system 502 can speak to a user of computer system 504 in real time (subject to network and processing delays; in some embodiments, the latter can be controlled to be less than 10 milliseconds to avoid perceptible lag). Further, although not shown in FIG. 5A, second computer system 504 can also implement a microphone system and first computer system 502 can also implement a speaker system, thereby enabling bidirectional voice communication between a user of first computer system 502 and a user of second computer system 504. For instance, users playing a game together over network 506 can converse with each other while playing the game. Microphone DSP 516 can apply a language-specific filter based on the language the user of first computer system 502 is speaking, and a microphone DSP(not shown) in second computer system 504 can apply a language-specific filter based on the language the user of second computer system 504 is speaking. Each computer system 502, 504 can independently determine the language its user is speaking (e.g., using any of the techniques described above with reference to process 400), and the two users need not be speaking the same language to each other.

FIG. 5B illustrates a local environment 550 according to some embodiments. In local environment 550, computer system 552 is coupled to a microphone 560. Microphone 560 can be a peripheral device, such as a handheld device, a wearable device (e.g., headset or earbud microphone, lapel mic, or the like), a stand-mounted device (e.g., in a webcam or freestanding microphone, or mounted in or on a housing of computer system 552), and microphone 510 can communicate with computer system 502 via a local connection such as USB, Bluetooth, an analog signal path, or the like; the connection can be wired or wireless. Microphone 560 and computer system 552 can implement microphone system 110 of FIG. 1. For example, computer system 552 can include a microphone DSP 566 (corresponding to microphone DSP 116 of FIG. 1 or DSP 200 of FIG. 2). Process 400 or similar processes can be implemented in microphone DSP 566 to apply baseline noise cancellation and a language-specific filter to audio data from microphone 560, and computer system 552 can thereby obtain filtered audio data. The filtered audio data can be used as input to various application programs executing on computer system 552, such as a media recording application program 572 that allows users to save and edit recordings of audio data or a speech-to-text application program 574 that converts audio data to a text-based representation of speech contained therein. Any application program capable of operating in any manner on filtered audio data can receive filtered audio data from microphone DSP 566.

It should be understood that FIGS. 5A and 5B are merely examples of operating environments that can benefit from techniques described herein. Depending on implementation, microphone 510 or microphone 560 can provide analog audio signals or digital audio data to computer system 502 or computer system 552. Further, where microphone 510 or microphone 560 is implemented as a peripheral device, microphone DSP 516 or 566 can optionally be incorporated into the physical housing of microphone 510 or 560 rather than in the main body of computer system 502 or computer system 552. It should also be understood that microphone 510 or microphone 560 can be physically integrated in the same housing as computer system 502 or computer system 552.

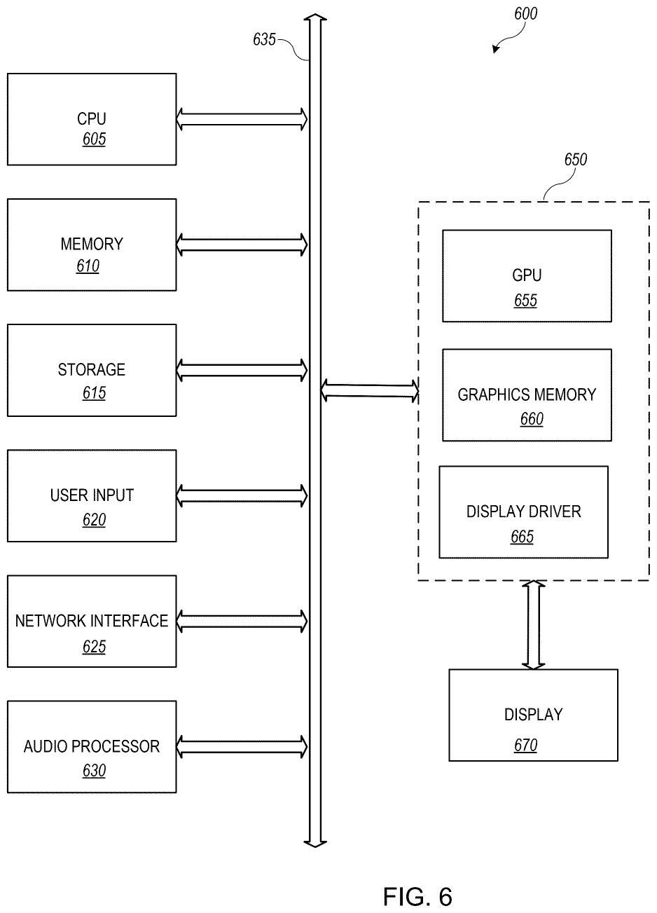

FIG. 6 shows a simplified block diagram of a hardware system suitable for implementing a computer system 600 according to some embodiments. The computer system 600 can be, for example, a video game system, a personal computer (e.g., laptop or desktop computer), a handheld computer (e.g., a tablet or smartphone or a self-contained microphone system), or other type of computer system including computer system 502 or 552. Computer system 600 can include a central processing unit (CPU) 605 capable of running software applications and optionally an operating system. CPU 605 can include one or more homogeneous or heterogeneous processing cores implemented in one or more integrated circuits. In various embodiments, CPU 605 can be implemented using general-purpose microprocessors and/or microprocessors whose architectures are specifically adapted for highly parallel and computationally intensive applications, such as media and interactive entertainment applications. Memory 610 can store applications and data for use by CPU 605 and can include any combination of volatile and/or non-volatile memory components (e.g., DRAM, SRAM, etc.). Storage subsystem 615 can provide non-volatile storage for applications and data and may include various computer readable media such as fixed disk drives, removable disk drives, flash memory devices, and CD-ROM, DVD-ROM, Blu-ray, HD-DVD, or other optical storage devices. User input devices 620 can include devices that communicate user inputs from one or more users to computer system 600. Examples of user input devices 620 can include keyboards, mice, thumbsticks, touch pads, touch screens, still or video cameras, and/or microphones. A microphone can include some or all of the components of microphone system 110 described above, disposed in a microphone housing and can have a variety of form factors, including a wearable device (e.g., headset or lapel mic); a handheld or stand-mounted device; or a microphone integrated with other devices or components such as a camera, a monitor, a handheld controller or a main body of a device implementing computer system 600. Network interface 625 allows computer system 600 to communicate with other computer systems via an electronic communications network. Network interface 625 can include hardware and associated software to support wired and/or wireless communication over local area networks and/or wide area networks such as the Internet. An audio processor 630 can be adapted to generate analog or digital audio output signals from instructions and/or data provided by CPU 605, memory 610, and/or storage subsystem 615. The components of computer system 600, including CPU 605, memory 610, storage subsystem 615, user input devices 620, network interface 625, and audio processor 630 can be connected via a data bus 635.

A graphics subsystem 650 can also be connected to data bus 635 and thereby to other components of computer system 600. Graphics subsystem 650 can include a graphics processing unit (GPU) 655, a graphics memory 660, and a display driver 665. GPU 655 can operate as a co-processor to CPU 605 to accelerate operations associated with generating and rendering images for display. For example, GPU 655 can support 3D rendering operations to generate pixel data for output images from instructions and data defining the geometry, lighting, shading, texturing, motion, and/or camera parameters for a scene, for instance by executing shader programs and/or other rendering programs or operations. Graphics memory 660 can include a display memory (e.g., a frame buffer) used for storing pixel data for each pixel of an output image. Graphics memory 660 (or portions thereof) can be integrated in the same device as GPU 655, connected as a separate device to GPU 655, and/or implemented within memory 610. Pixel data can be provided to the display memory of graphics memory 660 directly from CPU 605. Alternatively, CPU 605 can provide GPU 655 with data and/or instructions defining the desired output images, from which GPU 655 can generate pixel data for one or more output images. The data and/or instructions defining the desired output images can be stored in memory 610 and/or graphics memory 660. Display driver 665 can periodically output pixel data for an image from graphics memory 660 to be displayed on a display device 670. Display device 670 can be any device capable of displaying visual information in response to a signal from display driver 665 that incorporates the pixel data; examples include CRT, LCD, plasma, LED, and OLED displays. Depending on implementation, display driver 665 can provide display device 670 with an analog or digital signal.

To implement microphone audio processing in computer system 600, user input devices 620 can include a microphone as described above. Microphone DSP functions can be implemented using any combination of a dedicated signal processor within the microphone and/or software stored in storage subsystem 615 and/or memory 610 and executed using CPU 605 (which can include a co-processor or processing core optimized for computations associated with machine-learning models such as neural networks).

While the invention has been described with reference to specific embodiments, those skilled in the art will appreciate that variations and modifications are possible. For instance, a variety of baseline noise cancellation and language-specific filters can be implemented, and language-specific filters can be applied before or after the baseline noise-cancellation. In some embodiments, a language-specific filter can include either or both of a pre-filter that is applied prior to baseline noise cancellation (e.g., to pre-boost audio data components associated with phonemes of the target language) and/or a post-filter that is applied after baseline noise cancellation (e.g., to reduce sounds associated with certain phonemes that do not occur in the target language).

The current language context can be determined in numerous ways, using a combination of inputs including manual input (e.g., where the user selects a language from a menu) and/or automated language detection (e.g., based on geographic location and/or analysis of recently received audio data). In some embodiments, automated language detection can be performed while the user is speaking into the microphone (e.g., at regular intervals or each time the user says something), and the current language context can be periodically re-determined. The selection of a language-specific filter can be automatically changed in response to detecting a change in the current language context. Depending on implementation, there may be some lag between the user switching languages and the automated language detection process detecting the change. In some embodiments, the user can select between manual and automated language detection options, e.g., by changing a device setting via a user interface.

All processes described herein are also illustrative and can be modified. Operations can be performed in a different order from that described, to the extent that logic permits; operations described above may be omitted or combined or performed in parallel; and operations not expressly described above may be added. Further, some processes may be performed using a subset of the operations described herein.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code (e.g., software or firmware). Various blocks might or might not be reconfigurable depending on how the initial configuration is obtained. Embodiments of the present invention can be realized in a variety of apparatus including electronic devices implemented using a combination of circuitry and software.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein. A network may include both wired and wireless connections, including optical links. Many other examples are possible and will be apparent to those skilled in the art in light of this disclosure.

User interfaces for a given device can be implemented using various combinations of components. For instance, a graphical user interface may present a menu of options from which the user can select by operating an input device (e.g., mouse, thumbstick, buttons, etc.). A speech-based interface can be responsive to specific control words or phrases that the user may speak to change settings or invoke device functions. Some user interfaces can be implemented using switches, toggles, buttons, dials, or the like that the user can set to a desired position to control a device setting or function; feedback to the user can be provided via indicator lights, haptics, sounds, or other perceptual stimuli.

All numerical values and ranges provided herein are illustrative and may be modified. Unless otherwise indicated, drawings should be understood as schematic and not to scale. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Terms such as “approximately” or “substantially” should be understood to reflect manufacturing tolerance or expectations in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, although the invention has been described with respect to specific embodiments, it will be appreciated that the invention is intended to cover all modifications and equivalents within the scope of the following claims.

What is claimed is:

1. A method comprising:
receiving audio data from a microphone;
determining a current language context for the audio data, the current language context indicative of a language currently being spoken into the microphone;
selecting a first language-specific filter from a filter set based at least in part on the current language context, wherein the filter set includes a plurality of language-specific filters corresponding to different language contexts, the plurality of language-specific filters including the first language-specific filter; and
applying a plurality of filters, including a baseline noise cancellation filter and the first language-specific filter, to the audio data to produce filtered audio data.

2. The method of claim 1 wherein the audio data is received as digital audio data.

3. The method of claim 1 wherein determining the current language context includes analyzing audio data received from the microphone.

4. The method of claim 1 further comprising:
receiving and storing a language selection input from a user,
wherein determining the current language context is based at least in part on the language selection input.

5. The method of claim 1 wherein the language-specific filters are based at least in part on differences between phoneme sets of different spoken languages.

6. The method of claim 1 wherein the language-specific filters are based at least in part on differences in vocalization characteristics between different spoken languages.

7. The method of claim 1 wherein the baseline noise cancellation filter comprises a trained machine-learning model that was trained using a baseline language that is different from the language currently being spoken into the microphone.

8. The method of claim 1 further comprising:
obtaining a plurality of speech samples including speech samples in each of a plurality of different languages;
analyzing the speech samples to determine language-specific audio characteristics;
for each of the different languages, defining a language-specific filter based at least in part on the language-specific audio characteristics; and
storing the language-specific filters in the filter set.

9. The method of claim 1 further comprising:
transmitting the filtered audio data to an audio receiver system via a network.

10. A system comprising:
a microphone;
a memory; and
a processor coupled to the memory and the microphone, the processor being configured to:
receive audio data from the microphone;
determine a current language context for the audio data, the current language context indicative of a language currently being spoken into the microphone;
select a first language-specific filter from a filter set based at least in part on the current language context, wherein the filter set includes a plurality of language-specific filters corresponding to different language contexts, the plurality of language-specific filters including the first language-specific filter; and
apply a plurality of filters, including a baseline noise cancellation filter and the first language-specific filter, to the audio data to produce filtered audio data.

11. The system of claim 10 wherein the microphone produces an analog audio signal and wherein the system further comprises an analog-to-digital converter circuit configured to convert the analog audio signal to digital audio data.

12. The system of claim 10 wherein the processor is configured such that determining the current language context includes one or more of:
analyzing audio data received from the microphone; or
accessing a stored user language selection.

13. The system of claim 10 wherein the language-specific filters are based at least in part on differences between phoneme sets of different spoken languages.

14. The system of claim 10 wherein the language-specific filters are based at least in part on differences in vocalization characteristics between different spoken languages.

15. The system of claim 10 wherein the baseline noise cancellation filter comprises a trained machine-learning model that was trained using a baseline language that is different from the language currently being spoken into the microphone.

16. The system of claim 10 further comprising:
a network interface,
wherein the processor is further configured to transmit the filtered audio data to an audio receiver system using the network interface.

17. A computer-readable storage medium having stored therein program code instructions that, when executed by a processor in a computer system, cause the processor to perform a method comprising:
receiving audio data from a microphone;
determining a current language context for the audio data, the current language context indicative of a language currently being spoken into the microphone;
selecting a first language-specific filter from a filter set based at least in part on the current language context, wherein the filter set includes a plurality of language-specific filters corresponding to different language contexts, the plurality of language-specific filters including the first language-specific filter; and
applying a plurality of filters, including a baseline noise cancellation filter and the first language-specific filter, to the audio data to produce filtered audio data.

18. The computer-readable storage medium of claim 17 wherein the microphone produces an analog audio signal and wherein receiving the audio data from the microphone includes receiving the analog audio signal and converting the analog audio signal to digital audio data.

19. The computer-readable storage medium of claim 17 wherein the language-specific filters are based at least in part on one or more of:
differences between phoneme sets of different spoken languages; or
differences in vocalization characteristics between different spoken languages.

20. The computer-readable storage medium of claim 17 wherein the method further comprises:
obtaining a plurality of speech samples including speech samples in each of a plurality of different languages;
analyzing the speech samples to determine language-specific audio characteristics;
for each of the different languages, defining a language-specific filter based at least in part on the language-specific audio characteristics; and
storing the language-specific filters in the filter set.
